(19) United States
(12) Patent Application Publication
(10) Pub. No.: US 2026/0345404 A1
(43) Pub. Date: Nov. 5, 2026

(54) WHEELCHAIR LIFT ASSIST

(71) Applicant: Curt Christian, Hermitage, TN (US)

(72) Inventor: Curt Christian, Hermitage, TN (US)

(21) Appl. No.: 19/224,824

(22) Filed: Jun. 1, 2025

Related U.S. Application Data
(60) Provisional application No. 63/654,985, filed on Jun. 1, 2024.

(51) Int. Cl. A61G 5/14; A61G 5/02; A61G 5/08; A61G 5/10; A61G 5/12

(52) U.S. Cl. CPC A61G 5/14; A61G 5/02; A61G 5/0825; A61G 5/1054; A61G 5/122; A61G 5/124

(57) ABSTRACT

A lift-assist wheelchair includes a first side frame spaced apart from a second side frame, a plurality of wheels operably coupled with the first and second side frames, a seat positioned between and pivotally coupled with the first and second side frames, and a lift assist assembly operably coupled with the seat. The lift assist assembly includes a first arm having a front end and rear end and a second arm having a front and rear end.

### CROSS REFERENCE TO RELATED APPLICATIONS

This application claims the benefit of filing of US Provisional Application No. 63/654,985, filed on Jun. 1, 2024, and which is currently pending.

### FIELD OF THE DISCLOSURE

The present disclosure generally relates to a lift assist device for a wheelchair seat, and more particularly to a device that can assist an individual sitting and/or standing from a wheelchair.

### BACKGROUND OF THE DISCLOSURE

Wheelchairs and other mobilized chairs are often used by individuals for whom walking is difficult or impossible due to disabilities, illness, injury, or other health considerations. Wheelchairs are typically formed as a seat base with a plurality of supports extending downward from a bottom of the seat base and coupled with one or more wheels. Together, the wheels and the plurality of supports provide support for the wheelchair when it is place on a floor surface. Wheelchairs may also include a back rest that extends from a rear side of the seat base that can support an individual in an upright, seated position. Wheelchairs may be manual or motorized, may include footrests, and may include other features to provide ease of use and comfort to an individual, including armrests and other supports.

The seat base of a wheelchair is typically positioned so that the feet of an individual in the seated position are in contact or close proximity to a footrest or other support. While the height of the seat base is not particularly limited, and may vary depending on the intended use of a wheelchair, an individual must usually lower themselves into a seated position on the seatbase of the wheelchair in order to use the wheelchair. Conversely, when standing from a wheelchair or assisting an individual up from a wheelchair, the individual or other person providing aide must use physical force to lift the wheelchair user up from a seated position and off of the chair.

Sitting into or standing up from a seated position in a wheelchair can be difficult or impossible for some individuals. For example, some individuals may find it difficult or impossible to controllably lower themselves into a seated position on a wheelchair. Similarly, some individuals may lack the strength or flexibility to stand from a seated position on a chair. Difficulties in sitting or standing from chairs can impact the safety and well-being of such individuals. For instance, individuals may injure themselves attempting to sit or stand from a wheelchair when they lack the physical strength or flexibility to do so. Similarly, where another individual is assisting the wheelchair user, that individual may lack the physical strength to easily help the wheelchair user into or up from a sitting position within the wheelchair.

Individuals may compensate for difficulty sitting or standing by using arm strength to sit or stand from the wheelchair. Individuals may brace themselves on the arms or other portion of a wheelchair and use their arm strength to help control the rate at which they lower themselves onto the wheelchair. Individuals may also push off of a wheelchair with their arms to provide assistance when standing from a seated position. However, in doing so, an individual may inadvertently cause the wheelchair to slide or roll out from under the individual. This can cause an individual to incur additional strain or to fall. Such falls can result in serious injury, particularly if the individual is suffering from osteoporosis or other diseases or conditions. Serious injury can also occur if the individual hits their head in a fall.

Furthermore, some individuals lack the strength required to sit or stand from a wheelchair even when they utilize their arm strength to brace themselves. Such individuals are unable to sit or stand without personal assistance. Accordingly, such individuals may have reduced mobility, which can lead to other ailments.

Accordingly, there remains a need for a wheelchair that can assist an individual when sitting and/or standing from the wheelchair. There also remains a need for mechanisms that can reduce or eliminate the extent to which wheelchairs unintentionally slide when an individual attempts to sit or stand from the chair.

### SUMMARY OF THE DISCLOSURE

According to one aspect of the present disclosure, a wheelchair may include a first side frame spaced apart from a second side frame, a plurality of wheels operably coupled with the first and second side frames, a seat positioned between and pivotally coupled with the first and second side frames, and a lift assist assembly operably coupled with the seat. The lift assist assembly may include a first arm having a front end and rear end. The lift assist assembly may include a second arm having a front end and rear end. The first arm may be pivotally coupled with the first side frame about a point located between the front end and the rear end of the first arm. The second arm may be pivotally coupled with the second side frame about a point located between the front end and the rear end of the second arm. The first and second arms may be movable between a neutral position and a lowered position and may be configured to selectively move the seat from a depressed position to the raised position.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain view of the figures may be shown exaggerated in scale or in schematic in the interest of clarity and conciseness.

In the drawings:

FIG. 1A is a first front perspective view of a wheelchair with a lift assist assembly, according to various embodiments.

FIG. 1B is a second front perspective view of the wheelchair of FIG. 1A.

FIG. 2 is a third front perspective view of the wheelchair of FIG. 1A.

FIG. 3 is a side perspective view of the wheelchair of FIG. 1A.

FIG. 4A is a side profile view of the wheelchair of FIG. 1A showing a seat in a depressed position in solid lines and the seat in a raised position in dashed lines.

FIG. 4B is an enlarged side profile view of the wheelchair of FIG. 4A taken of the framed area IVA with the seat in the depressed position.

FIG. 4C is an enlarged side profile view of the wheelchair of FIG. 4A taken of the framed area IVA with the seat in the raised position.

FIG. 5 is a front view of the wheelchair of FIG. 1A.

FIG. 6 is a front view of the wheelchair of FIG. 1A in a folded position.

FIG. 7 is a top view of the wheelchair of FIG. 1A.

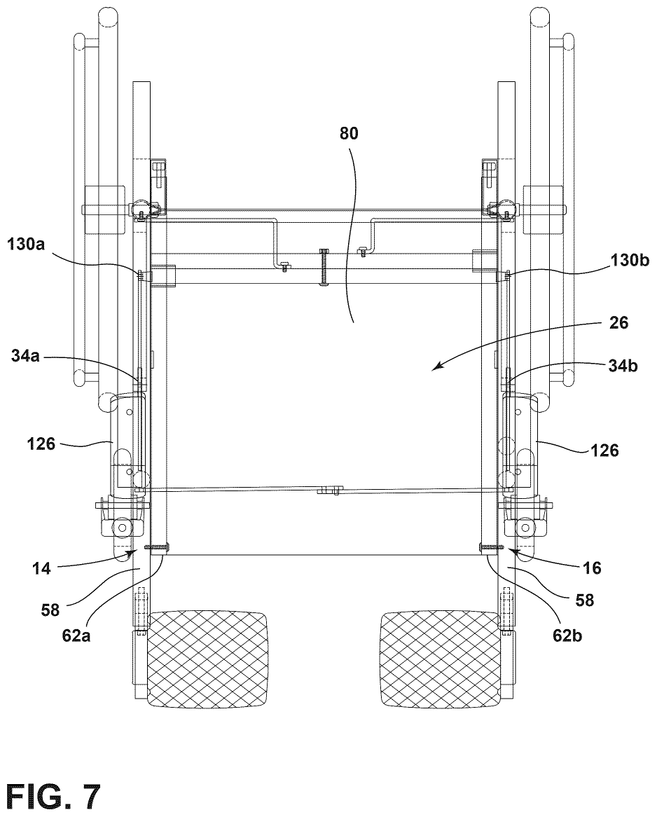

FIG. 8 is a top perspective view of the wheelchair of FIG. 1A.

### DETAILED DESCRIPTION

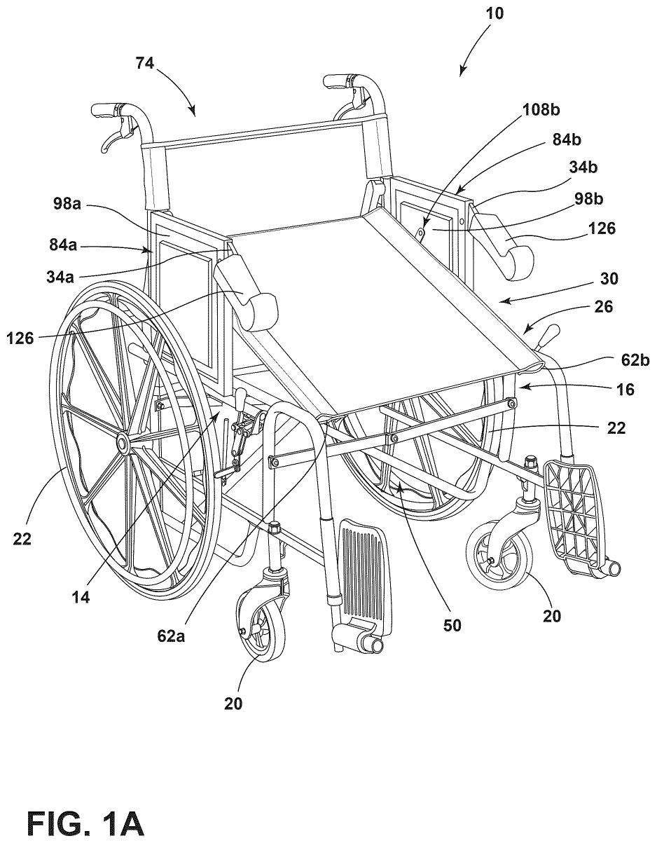

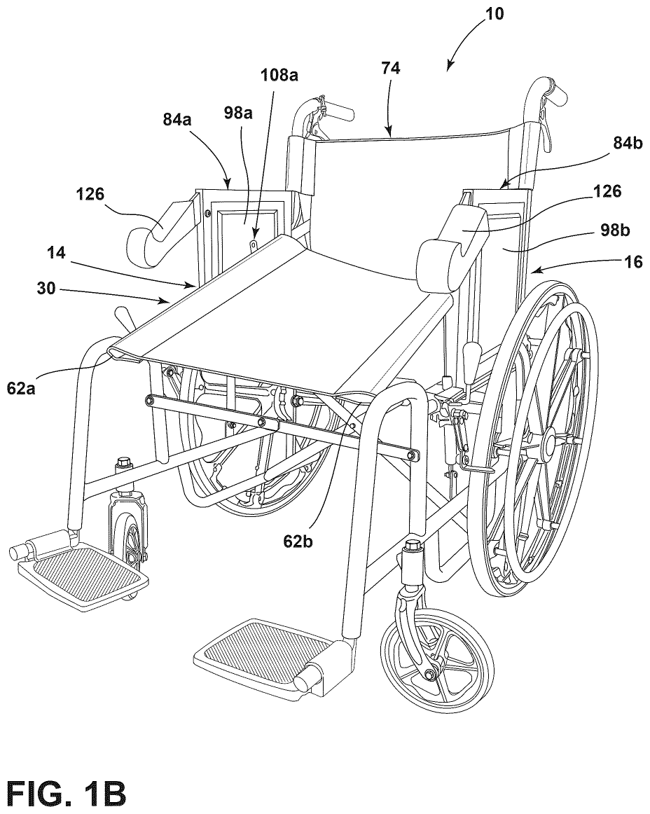

For purposes of description herein, the terms “upper,” “lower,” “right,” “left,” “rear,” “front,” “vertical,” “horizontal,” and derivatives thereof shall relate to the concepts as oriented in FIG. 1A. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed examples of the present disclosure are disclosed herein. However, it is to be understood that the disclosed examples are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and Bin combination; A and C in combination; B and C in combination; or A, B, and C in combination.

As used herein, the term “couple” is used interchangeably herein with the terms “connect,” “mount,” “attach,” and the like to refer to a connection between distinct components, including both permanent and non-permanent connections between components as well as both direct and indirect connections between components. For instance, two components may be coupled together by welds, bolts, screws, adhesives, or the like. In some instances, components that are not mechanically or chemically adhered together may be referred to as being coupled together if they are arranged such that movement of one component directly translates into movement of the other component.

The following disclosure describes a wheelchair 10 including a lift-assist assembly 30 configured to provide lift-assistance to a user of the wheelchair 10. In other words, the present-disclosed wheelchair 10 is configured such that an individual can have additional assistance when sitting into the wheelchair 10 relative to conventional wheelchairs. Embodiments of the presently-disclosed wheelchair 10 can also be configured such that an individual can have additional assistance when standing from the wheelchair 10 relative to conventional wheelchairs. In some embodiments, the presently-disclosed wheelchair 10 is configured such that an individual is assisted when sitting into the wheelchair 10 as well as when standing from the wheelchair 10. Accordingly, the presently-disclosed wheelchair 10 can aid elderly, disabled, injured, sick, and other individuals when sitting and/or standing. Such individuals may otherwise have difficulty or be unable to lower themselves into a seated position or raise themselves from a seated position.

Referring generally to the figures, in some embodiments, the wheelchair 10 includes a first side frame 14 spaced apart from a second side frame 16, a plurality of wheels 20, 22 operably coupled with the first and second side frames 14, 16, a seat 26 positioned between and pivotally coupled with the first and second side frames 14, 16, and a lift assist assembly 30 operably coupled with the seat 26. The lift assist assembly 30 includes a first arm 34a having a front end 36a and rear end 38 and a second arm 34b having a front end 36b and rear end 38. The first arm 34a is pivotally coupled with the first side frame 14 about a point located between the front end 36a and the rear end 38 of the first arm 34a, and the second arm 34b is pivotally coupled with the second side frame 16 about a point located between the front end 36b and the rear end 38 of the second arm 34b. The first and second arms 34a, 34b are movable between a neutral position and a lowered position and are configured to selectively move the seat 26 from depressed position to the raised position.

Referring now to FIGS. 1A and 1B, perspective views of an exemplary embodiment of a wheelchair 10 including a lift-assist assembly 30 are shown. The wheelchair 10 can resemble a traditional wheelchair in its assembled state. As previously introduced, the wheelchair 10 includes first and second side frames 14, 16 and a seat 26 positioned between the first and second side frames 14, 16. The first and second side frames 14, 16 are spaced apart and coupled by a plurality of cross-members 50. In various examples, the plurality of cross-members 50 may extend below, behind, or proximate the seat 26.

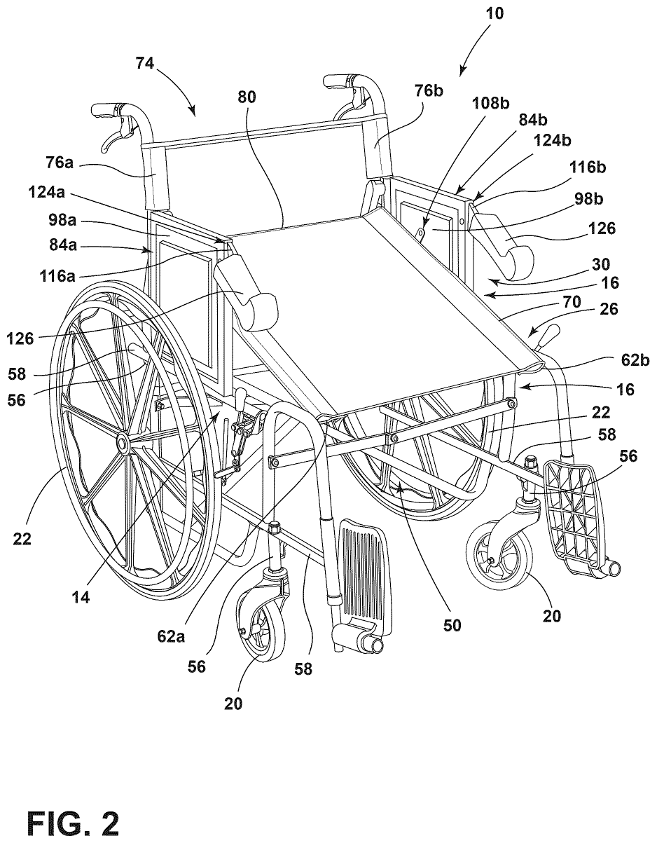

Referring now to FIGS. 1A-2, the first and second side frames 14, 16 may further include one or more vertical support members 56 and/or one or more horizontal support members 58 configured to support the wheelchair 10. The vertical support members 56 may be coupled with or integrally formed with the one or more horizontal support members 58. In various examples, the wheelchair 10 may include a forward pair of vertical support members 56 and a rear pair of vertical support members 56. In other examples, the wheelchair 10 may have a single pair of vertical support members 56. The vertical support members 56 may be substantially perpendicular relative a plane defined by the seat 26. The horizontal support members 58 may be configured to connect adjacent vertical support members 56 and may be configured to provide additional structural rigidity to the wheelchair 10.

In other embodiments any number and a variety of different shapes, sizes, and configurations of horizontal support members 58 may be provided at any location along the vertical supports 56 in order to enhance the wheelchair 10 aesthetically, structurally, or both. For instance, horizontal support members 58 may offer additional structural support to the wheelchair 10 by minimizing stress at junctions between the vertical support members 56 and other portions of the wheelchair 10, including, for example, the seat 26 or a back frame 74. Thus, in some instances support members 56, 58 can increase the horizontal forces that the wheelchair 10 can bear. It will be understood that the wheelchair 10 may include first and second side frames 14, 16 that include any number of vertical support members 56 and/or horizontal support members 58, depending on the configuration and purpose of the wheelchair 10.

As shown in FIGS. 1A-2, forward wheels 20 are rotatably coupled with forward portions of the first and second side frames 14, 16. For example, the forward wheels 20 may be provided at distal ends of two forwardly disposed vertical support members 56. Rear wheels 22 are rotatably coupled with rear portions of the first and second side frames 14, 16. For example, the rear wheels 22 may be provided along two rearwardly disposed vertical support members 56 and/or at a distal end of two horizontal support members 58. The rear wheels 22 may be larger than the forward wheels 20. The forward wheels 20 and rear wheels 22 are positioned on the side frames 14, 16 such that the wheelchair 10 is level when the forward wheels 20 and the rear wheels 22 are placed on a floor surface. In various examples, breaking mechanisms may be coupled with one or more of the wheels 20, 22. The wheels 20, 22 are configured such that an individual may selectively move the wheelchair 10 by rolling the wheelchair 10 so that it can roll along the floor surface on the wheels 20, 22.

Referring now to FIGS. 1A-3, the wheelchair 10 further includes the seat 26. The seat 26 may include a seat frame 62. For example, the seat 26 may include a first lateral member 62a and a second lateral member 62b. The first lateral member 62a may be pivotally coupled with the first side frame 14. The second lateral member 62b may be pivotally coupled with the second side frame 16. The first lateral member 62a extends proximate to the first side frame 14, and the second lateral member 62b extends proximate to the second side frame 16.

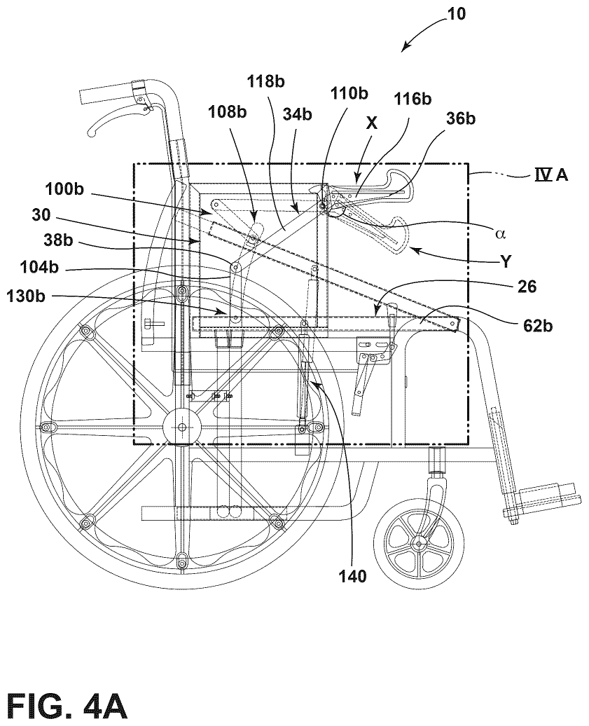

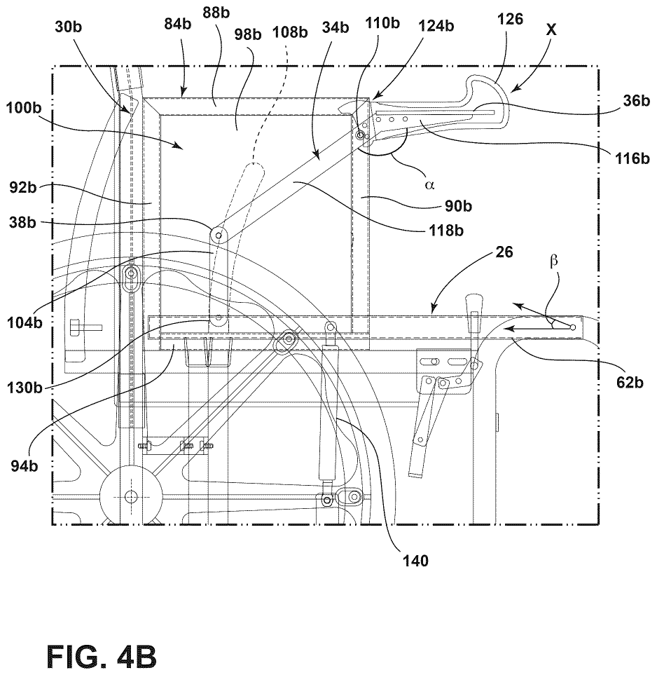

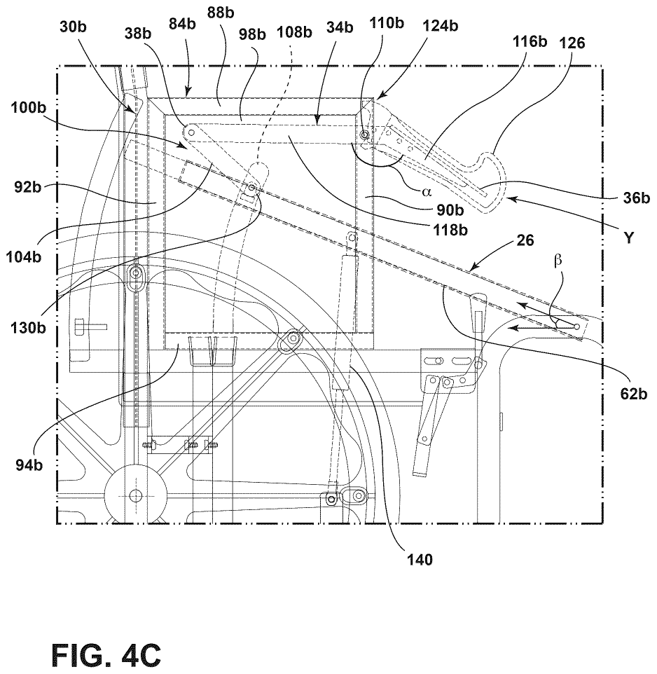

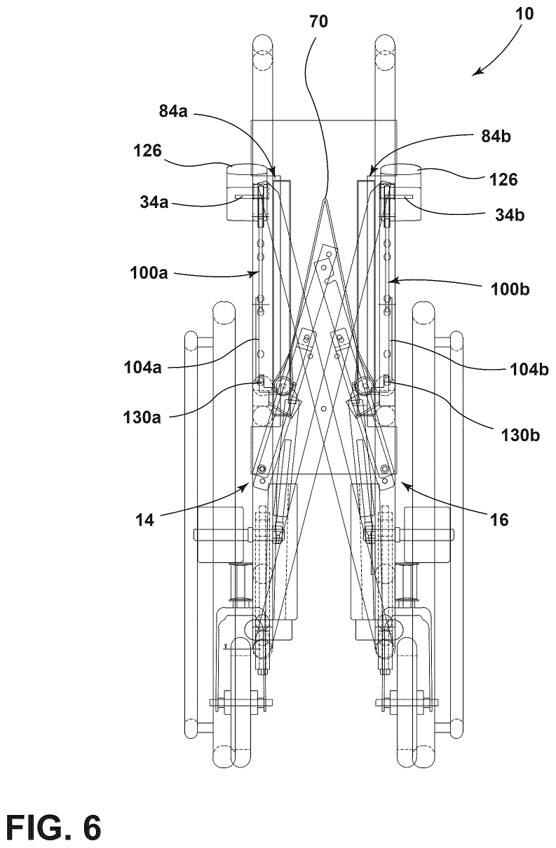

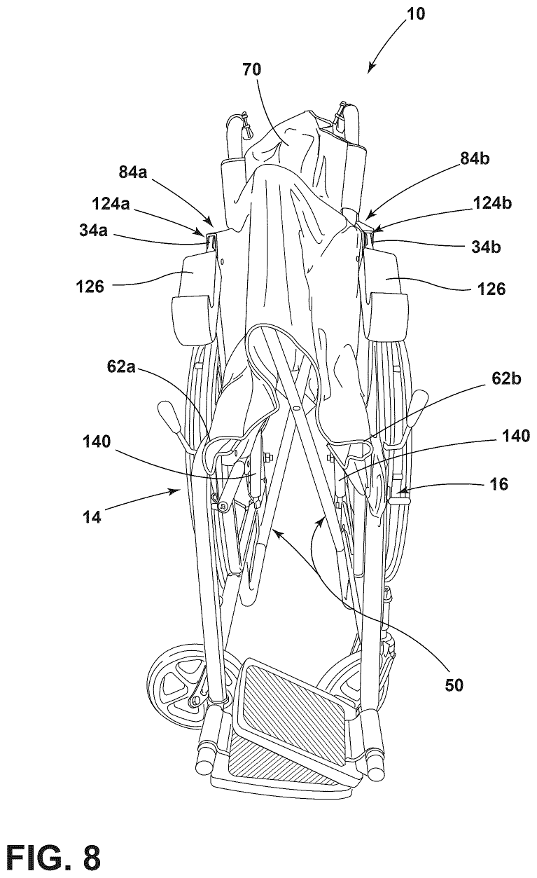

A flexible material 70 may extend between the first and second lateral members 62a, 62b. Together, when the wheelchair 10 is in a use position (see FIG. 4A and labeled X), the first and second lateral members 62a, 62b and the flexible material 70 may define a substantially planar surface. The flexible material 70 may be any material having cushioning properties configured to create a seat when an extended position (i.e., when the wheelchair 10 is in the use position) and configured to compress, fold, or otherwise collapse when in a compressed position (i.e., when the wheelchair 10 is in the folded position as shown in FIGS. 6 and 8). In various examples, the flexible material 70 may include sleeves configured to receive the first and second lateral members 62a, 62b such that the flexible material 70 extends between the first and second lateral members 62a, 62b. The flexible material 70 may be coupled with the first and second lateral members 62a, 62b by any suitable mechanical or chemical adhesive, including nails, screws, staples, tape, glue, or the like. In various examples, a cushion or other seat base may be operably coupled with or positioned on the flexible material 70. Thus, the term seat base as used herein refers to seat bases formed of a seat frame and support material that may or may not comprise a seat cushion, wherein the seat cushion can be defined by the seat, a separate component that is supported and/or provided on the seat base, or integral with the seat base.

In the embodied wheelchair 10 the seat 26 may include a front edge, a rear edge, a first lateral edge, and a second lateral edge. In the embodied wheelchair 10, the first and second lateral edges may be defined by the first and second lateral members 62a, 62b. The rear edge corresponds to a rear end of the generally rectangular seat 26. In this regard, the term “edge” generally refers to an area of a structure located along a given side of the structure. For instance, the term “lateral edge” refers to both the physical lateral side of a structure as well as top and bottom surface areas of provided along the lateral side of the structure.

Furthermore, the rear edge corresponds to a rearwardly disposed component that spans between the lateral edges. However, in other embodiments the rear edge may not correspond to the rear end of a seat. For instance, in some embodiments the seat forms a generally U-shaped structure, and rear edge corresponds to a component that spans between mid-points along the lengths of the lateral edges.

The components that comprise the edges of the seat 26 are configured in an arrangement having a substantially rectangular shape. In some embodiments the seat 26 is comprised of fewer than three components, and in other embodiments the seat frame is comprised of more than three components. In other embodiments a seat frame can take any shape that is appropriate for the intended use of a chair. The components of a seat are not particularly limited, and in some embodiments are comprised of a material selected from wood, composite, polymer, metal, or the like. In yet other embodiments, a seat is comprised of a unitary component, such as a continuous metal sheet, plastic, or the like.

Referring now to FIG. 2, in various examples, the wheelchair 10 may also include a back frame 74 that extends upwardly from a rear edge of the seat 26. The back frame 74 may include first and second lateral members 76a, 76b. In various examples, the first and second lateral members 76a, 76b may be coupled with or integrally formed with the first and second side frames 14, 16, respectively. The back frame 74 may include a back cushion, back fabric, or other material extending between the first and second lateral members 76a, 76b and configured to support the back of a user when the user is sitting in the wheelchair 10. In some embodiments the back frame 74 is comprised of one or more materials that have cushioning properties. In other embodiments, the back frame 74 is a rigid frame or continuous material, and a back cushion is provided as a separate component on a surface of a back frame. The back cushion can be connected to the first and second lateral members 76a, 76b by any suitable mechanical or chemical adhesive, including nails, screws, staples, tape, glue, or the like. Thus, the term back frame, as used herein, refers to back frames that may or may not comprise a back cushion, wherein the back cushion can be defined by the seat, a separate component that is supported and/or provided on the seat, or integral with the seat.

As shown in FIG. 2, the back frame 74 can be disposed toward the rear edge of the seat 26 and extends upwardly relative to a top side 80 of the seat 26. In some embodiments, the back frame 74 may be coupled to the seat 26. The back frame 74 is configured to support an individual in the seated position. Embodiments of back frames can be configured to have any suitable shape or size. Depending on the intended use of a wheelchair 10, the back frame 74 relative to the seat 26 can form an angle of about 90 degrees to about 180 degrees, including about 90, 95, 100, 105, 110, 115, 120, 125, 130, 135, 140, 145, 150, 155, 160, 165, 170, 175, or 180 degrees, including and ranges therebetween. In some embodiments, the angle of the back frame 74 relative to the seat 26 may be adjustable.

Referring now to FIGS. 1A-3, the wheelchair 10 may further include the lift assist assembly 30. The lift assist assembly 30 may include first and second arms 34a, 34b movable between a neutral position and a lowered position. The first and second arms 34a, 34b may be coupled with the seat 26 such that the neutral position of the first and second arms 34a, 34b corresponds with the depressed position of the seat 26 and the lowered position of the first and second arms 34a, 34b corresponds with the raised position of the seat 26. In other words, movement of the first and second arms 34a, 34b from the neutral position to the lowered position is configured to move the seat 26 from the depressed position to the raised position. Movement of the seat 26 from the raised position to the depressed position is configured to move the first and second arms 34a, 34b from the lowered position to the neutral position. While the lift assist assembly 30 is described herein as having first and second arms 34a, 34b and related components, it is contemplated that the lift assist assembly 30 may include only the first arm 34a or the second arm 34b and the respective related components without departing from the scope of the present disclosure. In other words, the lift assist assembly 30 may include only one arm and related components without departing from the scope of the present disclosure.

Referring now to FIGS. 2-5, a first arm support 84a may be provided proximate the first lateral member 62a of the seat 26. The first arm support 84a may be integrally formed with or may be coupled with the first side frame 14. In some embodiments, the first arm support 84a may be coupled to a side or a top of the first lateral member 62a of the seat 26. A second arm support 84b may be provided proximate the second lateral member 62b of the seat 26. The second arm support 84b may be integrally formed with or may be coupled with the second side frame 16. In some embodiments, the second arm support 84b may be coupled to a side or a top of the second lateral member 62b of the seat 26. In other embodiments, one or both of the arm supports 84a, 84b may be coupled with the back frame 74. In still other embodiments, one or both of the arm supports 84a, 84b may be coupled to the seat 26 in any manner that permits the seat 26 to move between a depressed position and a raised position.

Each arm support 84a, 84b may include a top edge 88, a forward edge 90, a rear edge 92, and a lower edge 94. Each edge 88, 90, 92, 94 may be formed of a member, a wall, or other edge defining component. The forward and rear edges 90, 92 of each arm support 84 may extend upwardly relative to a top side of the seat 26. The top edges 88 and the lower edges 94 of each arm support 84a, 84b may extend substantially perpendicular to the respective forward and rear edges 90, 92.

FIGS. 4A-4C show a side cross-sectional views of the wheelchair 10 with the seat 26 in the depressed position with the arm 34b in the neutral position (solid lines X) and with the seat 26 in the raised position with the arm 34b in the lowered position (dashed lines Y). The reference numerals identified are associated with the components on the right side of the wheelchair 10 (i.e., the second arm 34b, the second arm support 84b, the second arm connector 104b, etc.) in the depressed position; however, it will be understood that the reference numerals also apply to the same components as shown in the raised position.

As best shown in FIGS. 4A-4C, the edges 88b, 90b, 92b, 94b of the second arm support 84b may be linear and the second arm support 84b may be shaped as a rectangle or square. However, it is contemplated that one or more of the edges 88b, 90b, 92b, 94b may be nonlinear and/or the second arm support 84b may have any shape without departing from the scope of the present disclosure. It is further contemplated that the second arm support 84b may include only one of the edges 88b, 90b, 92b, 94b, two of the edges 88b, 90b, 92b, 94b, three of the edges 88b, 90b, 92b, 94b, or any other number of edges without departing from the scope of the present disclosure.

As shown in FIGS. 1A-5, in various examples, the wheelchair 10 may further includes side panels 98a, 98b provided on the lateral sides of the wheelchair 10. The side panels 98a, 98b may be operably coupled with the first and second side frames 14, 16. In various examples, each side panel 98a, 98b may be a pair of side panels positioned on opposing sides of the respective arm support 84a, 84b.

The first side panel 98a may at least partially define a receiving space 100a configured to receive a portion of the first arm 34a and the first arm connector 104a, and the second side panel 98b may define a receiving space 100b configured to receive a portion of the second arm 34b and the second arm connector 104b. For example, together with the first side panel 98a, the first arm support 84a may define the first receiving space 100a, and together with the second side panel 98b, the second arm support 84b may define a second receiving space 100b.

With continued reference to 1A-5, a portion of each of the first arm connector 104 a and the second arm connector 104b may extend from or be aligned with openings 108a, 108b provided in the side panels 98a, 98b. The openings 108a, 108b may be shaped as arc or may have any other shape to allow the necessary movement of the respective arm connector 104a, 104b as attached to the seat 26. In some embodiments, the side panels 98a, 98b may provide a covering for the mechanical components of the wheelchair 10. Thus, embodiments of coverings of different shapes and sizes can be provided depending on the intended use of the wheelchair 10.

As shown in FIGS. 4A-4C, the second arm 34b is provided that has a length and includes a front end 36b and a rear end 38b. The second arm 34b may be pivotally coupled to the second arm support 84b so that the second arm 34b can move about its connection point 110b with the second arm support 84b. For example, the second arm 34b may be pivotally coupled to the forward edge 90b of the second arm support 84b. Accordingly, the front end 36b and the rear end 38b of the second arm 34b move in opposite vertical directions as the second arm 34b is pivoted about its connection point with the second arm support 84b.

The second arm 34b has a shape that includes a front portion 116b and a rear portion 118b. The front portion 116b and the rear portion 118b may be formed to create an angle A. In various examples, the connection point of the second arm 34b with the second arm support 84b may be positioned proximate the joinder of the front portion 116b and the rear portion 118b of the second arm 34b. In other examples, the second arm 34b may include a shape that is substantially straight between the front end 36b and the rear end 38b. In other embodiments, the second arm 34b may include a shape that is curved, and in certain embodiments, the second arm 34b may include a shape that is curved upwardly so that the front end 36b, the rear end 38b, or the front end 36b and the rear end 38b are disposed higher than a middle point located along a length of the second arm 34b.

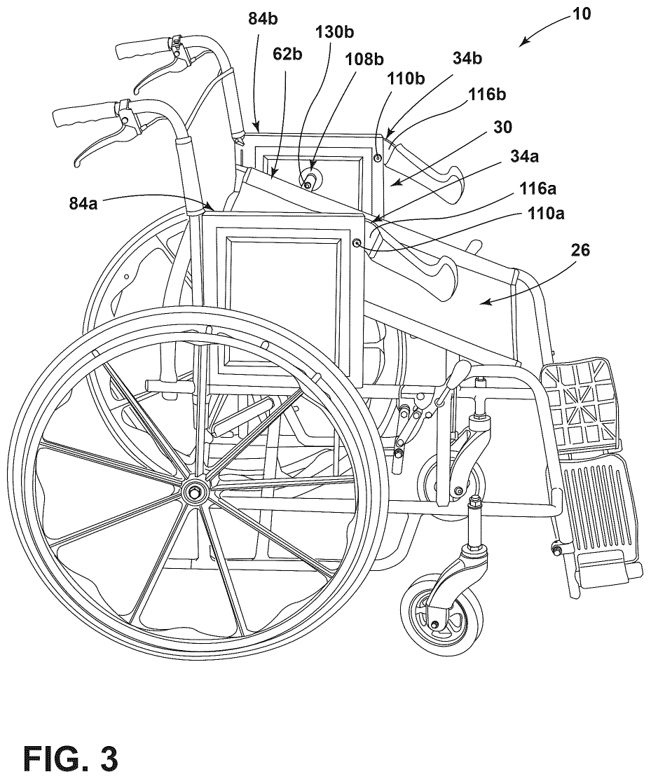

In various examples, the second arm 34b may be positioned within the second receiving space 100b. Where the second receiving space 100b is defined by the forward edge 90b of the second arm support 84b, the forward edge 90b may include an opening 124b configured to receive the front end 36b of the second arm 34b. As shown in FIGS. 2 and 3, the first arm 34a may be positioned within the first receiving space 100a such that the front portion 116a of the first arm 34a extends outward from the opening 124a, and the second arm 34b may be positioned within the second receiving space 100b such that the front portion 116b of second arm 34b extends outward from the opening 124b. A handle 126 may be coupled with the front portion 116a of the first arm 34a. Another handle 126 may be coupled with the front portion 116b of the second arm 34b.

Referring again to FIGS. 4A-4C, the wheelchair 10 further includes the second arm connector 104b. One end of the second arm connector 104b is coupled to the second arm 34b. For example, the second arm connector 104b may be coupled with the rear end 38b of the second arm 34b. In other embodiments, the second arm connector 104b may be coupled to any point located between the rear end 38b of the second arm 34b and the point where the second arm 34b is coupled to the second arm support 84b. Thus, the second arm connector 104b is generally disposed towards the rear end 38b of the second arm 34b relative to connection point between the second arm 34b and the second arm support 84b.

Another end of the second arm connector 104b opposite the end that is coupled to the second arm 34b is coupled to the seat 26. For example, the second arm connector 104b may be coupled to the second lateral member 62b of the seat 26. The second arm connector 104b may be coupled with the second lateral member 62b such that the connection point is disposed towards the rear edge of the seat 26.

In various examples, a bracket (e.g., a second arm connector bracket 130b) or other connector may be used to couple the second arm connector 30b with the second lateral member 62b of the seat 26. The second arm connector 104b is coupled with the second lateral member 62b of the seat 26 such that, when second arm connector 104b is moved upwardly, the second arm connector bracket 130b can lift the seat 26 from a depressed position to a raised position. In some embodiments the bracket 130b may be fixably coupled to the seat 26 with, for example, an adhesive, bolt, screw, or the like.

With continued reference to FIGS. 4A-4C, the embodied wheelchair 10 may include pivoting connections between the second arm connector 104b and the second arm 34b as well as between the second arm connector 104b and the seat 26. In this respect, the second arm connector 104b may be configured to be pivotally coupled with the second lateral member 62b of the seat 26.

In other embodiments, the second arm connector 104b may not include a bracket or other connector, and the second arm connector can be coupled to the seat base directly or indirectly through another component. In this regard, the term “arm connector” as used herein refers to any component that couples the arm to the seat base in a manner that permits movement of the arm to translate into movement of the seat base. Thus, the term arm connector is used herein to refer to connectors that include one or more components and that couple the arm to the seat base. In some embodiments an arm connector may or may not comprise a bracket for coupling to a seat base.

It will be understood that any of the pivoting connections or couplings described herein can be achieved by any means known in the art. For instance, a first component may be bolted to a second component so that it can pivot about an axis that is defined by the bolt. In other instances, a pivoting coupling can be achieved by permitting movement of two component as they move in relation to one another. For instance, in embodiments wherein a seat base rests on a top surface of an arm connector without being fixedly fastened thereto, the seat base can pivot with respect to the arm connector as they move in relation to one another. Furthermore, in some embodiments pivoting couplings can include two components that are fixedly fastened to one another, wherein at least one of the components is flexible so that the components may be moved respect to each other.

As described herein, the wheelchair 10 may further comprise the first arm 34a, the first arm support 84a, and the first arm connector 104a positioned proximate the first side frame 14. In the embodied wheelchair 10, the first arm 34a, the first arm support 84a, and the first arm connector 104a are configured to mirror the second arm 34b, the second arm support 84b, and the second arm connector 104b, respectively, as described such features are described in detail herein with reference to FIGS. 4A-4C. Accordingly, in some embodiments all the statements made herein with respect to a second component shown in FIGS. 4A-4C are applicable to the corresponding first component.

On other embodiments a first component will differ from a corresponding second component. For instance, in some embodiments only one of a first arm and a second arm are configured to pivot and move a seat base between a depressed position and a raised position, whereas the other arm is stationary and does not influence the movement of the seat base. In other embodiments, corresponding first and second components are not symmetrical. Possible differences between corresponding first and second components in other embodiments will be appreciated by those of ordinary skill upon reviewing this document.

The arms can be modified or adjusted depending on the intended use or design of a chair. In some embodiments the front end of an arm may define a handle having an aesthetically pleasing design and/or being configured to be comfortable for placement of an individual's hands. In some embodiments, the arms can be comprised of two or more separate components that together function as an arm. In other embodiments, the arms may be directly coupled with the seat without an arm connector or bracket.

Referring again to FIGS. 1A-5, the wheelchair 10 in the depressed position represents a configuration when a force is applied to the top side of the seat 26. The depressed position can therefore represent a position of the seat 26 when an individual is seated on the wheelchair 10. In the depressed position, the seat 26, including the flexible material 70 and the first and second lateral members 62a, 62b, are horizontal and substantially parallel to one another. In still other embodiments, the first and second lateral members 62a, 62b in the depressed position are not horizontal but are substantially parallel. For instance, it may be desirable to have a wheelchair that has a seat that is tilted forward or backwards in the depressed position so that the wheelchair has an inclined or declined seated position.

The wheelchair 10 in the raised position represents a configuration when no force or a force insufficient for depression is applied to the top side of the seat 26. The raised position can therefore represent a position of the seat 26 when an individual is not seated on the wheelchair 10. In the extended position, the seat 26 is angled relative to the location of the seat 26 in the depressed position, the angle B being generally defined by the tilt of the seat 26 in the extended position relative to the seat 26 in the depressed position. In some embodiments the angle of the seat 26 in the extended position relative to the seat 26 in the depressed position is about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 degrees, including any ranges and values therebetween. In some embodiments the angle of the seat 26 in the extended position relative to the seat 26 in the depressed position is about 5 to about 90 degrees.

In other embodiments, the wheelchair may be provided with one or more pivot points along a front edge of the seat. A front side of a seat base may be coupled to hinges that are provided along a front edge of a seat frame. In this manner, the seat base may be pivotally coupled to a front edge of a seat frame or other portion of the wheelchair. The hinges may be configured to permit a seat base or cushion to tilt with respect to a seat frame between the depressed position and the extended position as opposed to having the entire seat move. Other embodiments comprise other configurations for achieving such movement of a seat base relative to a seat frame. For instance, in some embodiments the hinges are substituted for other pivoting or flexible components that permit the seat base to pivot with respect to the seat frame. In other embodiments hinges or other pivoting or flexible components are provided on other portions of the seat frame depending on the arrangement of the seat base relative to the seat frame.

The wheelchair 10 may include a seat stop disposed proximate the seat 26. For example, the seat stop may be positioned on one of the first and second side frames 14, 16 or, where the seat 26 includes a seat base moving separately from a seat frame, on the seat frame. The seat stop may include one or more objects that, when the seat 26 is in the depressed position, stop movement of the seat 26. The material and configuration of the seat stop is not particularly limited. In some embodiments, one or more components comprise a seat stop that determine the position of the seat 26 in the depressed position. The seat stops may be arranged at suitable any location and in any suitable pattern. Alternatively or additionally, seat stops that determine the position of a seat 26 in the depressed position may be provided on the first and second side frames 14, 16, the first and second arm supports 84a, 84b, or another portion of a chair. In some embodiments the seat stop may be integral with a seat frame. The seat stop may be made of any suitable material, including metal, wood, felt, rubber, plastic, or the like.

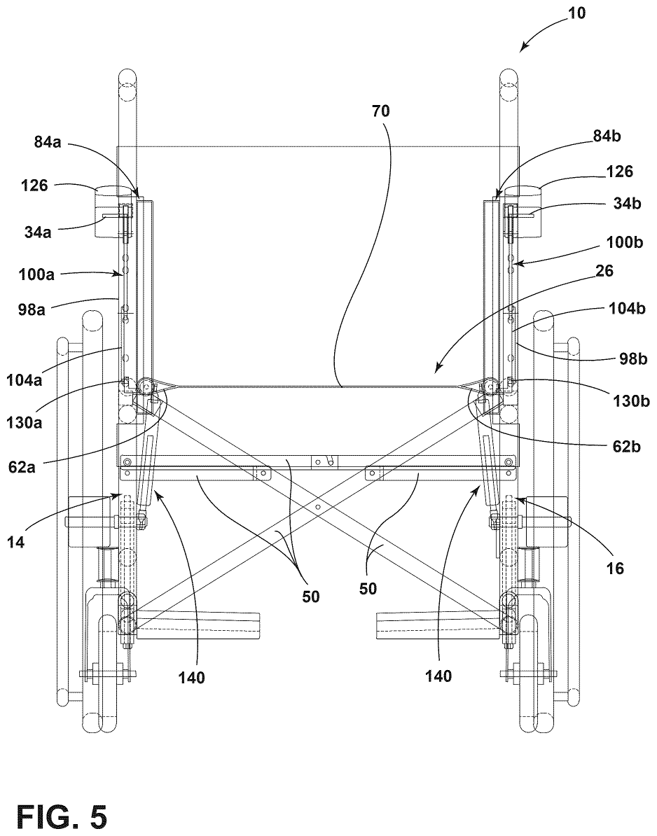

The wheelchair 10 may further include a biasing mechanism 140 configured to bias the seat 26 from the depressed position to the raised position. For example, as shown in FIG. 3, the wheelchair 10 may include a pneumatic biasing mechanism. The biasing mechanism may be one of a pair of biasing mechanisms positioned on either side of the seat 26 or may be a single biasing member. The biasing mechanism 140 is configured to exert a force against a bottom side of the seat 26. For example, as shown in FIGS. 4A-5, the biasing mechanism 140 may be operably coupled with one of the first and second lateral members 62a, 62b of the seat 26. Thus, the biasing mechanism 140 can assist movement of the seat 26 from a depressed position to a raised position. In some embodiments, the biasing mechanism can independently move a seat base from a depressed position to a raised position. In other embodiments, the biasing mechanism 140 in conjunction with force applied by an individual to the lift-assist assembly 30 can move the seat 26 from a depressed position to a raised position. The biasing mechanism 140 may also be configured to reduce the rate at which the seat 26 moves from a raised position to a depressed position and/or from a depressed position to a raised position. This can assist an individual in achieved controlled and gradual movement of the seat 26 into and out of the depressed position. It is contemplated that the wheelchair 10 may comprise any number of such biasing mechanisms or other compression mechanisms. It is further contemplated that the seat stop and the biasing mechanism may be coupled together or integrally formed as a single mechanism without departing from the present disclosure.

A method for operating the embodied list-assist wheelchair 10 will now be described. When sitting, an individual can apply a downward force on the front ends 36a, 36b of the arms 34a, 34b to move the arms 34a, 34b from a neutral position to a lowered position. For example, the individual may depress the handles 126 to move the arms 34a, 34b from a neutral position to a lowered position. As shown in FIG. 4A, this downward force causes the arms 34a, 34b to pivot about the connection points with the arm supports 84a, 84b so that the rear ends 36a, 36b of the arms 34a, 34b lift upwardly. In turn, as the rear ends 38a, 38b of the arms 34a, 34b lift upwardly, the arm connectors 104, 104b the rear side of the seat 26 to also lift upwardly. In other words, the rear ends 38a, 38b of the arms 34a, 34b lifting upwardly causes the arm connectors 104a, 104b to lift, causing the rear ends of the lateral members 62a, 62b of the seat 26 to move upward. This configuration, wherein the front ends 36 of the arms 34 are pivoted downward into the lowered position, is configured to lift the seat 26 into the raised position. In other words, the neutral position of the arms 34 corresponds with the depressed position of the seat 26 and the lowered position of the arms 34 corresponds with the raised position of the seat 26.

An individual may apply force on the seat 26 as they lower themselves into the wheelchair 10 to sit. During this time, one may continue to apply a desired amount of downward force on the front ends 36 of the arms 34 in order to counteract the force of their weight on the seat 26. Furthermore, since the seat base 26 is tilted upwardly in the extended position, the distance an individual must lower themselves before making contact with the wheelchair 10 is decreased relative to a traditional wheelchair. These factors help reduce the strain that is placed on an individual's legs and arms as they attempt to lower themselves into a seated position, and also permits individuals to sit in a more gradual and safe manner.

As an individual continues to lower themselves, the seat 26 will lower to a predetermined point. For example, the seat 26 may lower until the seat 26 contacts a seat stop or until the biasing mechanism 140 no longer allows for further downward movement. A position wherein an individual is seated on the wheelchair 10 is referred to herein as the “depressed position.” The mass of an individual is in a seated position can hold the arms 34 in the neutral position against any force exerted by the biasing mechanism 140.

The presently-disclosed wheelchair 10 can also assist an individual who desires to stand from a seated position. As one prepares to stand, they can apply a downward force on the front ends 36 of the arms 34 (e.g., on the handles 126). This downward force on the arms 34 is communicated through the arms 34 and/or the arm connectors 104 to apply an upward force on the seat 26 and tilt the seat 26 upwardly from a depressed position to a raised position. As the individual begins to stand, the seat 26 will continue moving upwardly to assist the individual to stand up from a seated position. In this manner, one can utilize both upper body strength and mass to facilitate standing from the wheelchair 10.

In this regard, the location and arrangement of the seat 26 and any associated frame members (e.g., the first and second lateral members 62a, 62b), the arm supports 84a, 84b, the arms 34a, 34b, the arm connectors 104a, 104b, and any cushion members of the seat 26 (e.g., the flexible material 70 or other cushion) can be altered depending on the particular configuration of a chair. For instance, the configuration of these elements can be altered to increase or decrease the amount of leverage the arms provide when moving a seat base relative to a seat frame or when moving the seat relative to the first and second side frames or other portions of the wheelchair frame. In some embodiments, a portion of an arm support can be coupled to a lateral edge of a seat or seat frame at any location between a rear edge and a front edge of the seat or seat frame. Similarly, in some embodiments, a portion of an arm support can be coupled to an arm at any location between a front end and a rear end of the arm. Furthermore, in some embodiments an arm connector can be coupled to any point on an arm and on any point of a seat, seat frame, or seat base.

The presently-disclosed lift-assist wheelchair can provide numerous advantages. For those who are disabled, injured, elderly, or the like, the wheelchair can greatly ease the process of sitting and standing into the wheelchair, with or without assistance.

As shown in FIGS. 6 and 8, it is contemplated that the wheelchair 10 may be foldable/collapsible to allow for easier storage and movement. Accordingly, the cross-members 50 may be collapsible and the flexible material 70 may be compressible. The lift assist assembly 30 may be configured to be unaffected by folding the wheelchair 10, as the lift assist assembly 30 may be primarily confined to the area proximate the first and second side frames 14, 16 which are retain their shape in the folded position.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

It will be understood by one having ordinary skill in the art that construction of the described concepts, and other components, is not limited to any specific material. Other exemplary embodiments of the concepts disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. A lift-assist wheelchair comprising:
a first side frame spaced apart from a second side frame;
a plurality of wheels operably coupled with the first and second side frames;
a seat positioned between and pivotally coupled with the first and second side frames;
a lift assist assembly operably coupled with the seat and including:
a first arm having a front end and rear end, the first arm pivotally coupled with the first side frame about a point located between the front end and the rear end; and
a second arm having a front end and rear end, the second arm pivotally coupled with the second side frame about a point located between the front end and the rear end, the first and second arms movable between a neutral position and a lowered position, wherein the first and second arms are configured to selectively move the seat from depressed position to the raised position.

2. The lift-assist wheelchair of claim 1, wherein the lift-assist assembly further includes a first handle coupled with the first arm and a second handle coupled with the second arm.

3. The lift-assist wheelchair of claim 1, wherein the plurality of wheels comprises:
a first forward wheel coupled with the first side frame and a second forward wheel coupled with the second side frame; and
a first rear wheel coupled with the first side frame and a second rear wheel coupled with the second side frame, wherein each of the first and second rear wheels is larger than each of the first and second forward wheels.

4. The lift-assist wheelchair of claim 1, wherein:
the first arm includes a front portion and a rear portion, the front portion and the rear portion defining a first angle; and
the second arm includes a front portion and a rear portion, the front portion and the rear portion defining a second angle.

5. The lift-assist wheelchair of claim 1, wherein the lift assist assembly further includes:
a first arm connector having a first end and a second end, wherein the first end of the first arm connector is pivotally coupled with the rear end of the first arm and the second end of the first arm connector is operably coupled with the seat frame; and
a second arm connector having a first end and a second end, wherein the first end of the second arm connector is pivotally coupled with the rear end of the second arm and the second end of the second arm connector is operably coupled with the seat frame.

6. The lift-assist wheelchair of claim 1, further comprising:
a biasing member operably coupled with the seat frame, the biasing member configured to bias the seat frame in the raised position.

7. The lift-assist wheelchair of claim 1, wherein the seat comprises:
a seat frame positioned between the first and second side frame and having a first lateral member and a second lateral member, wherein the seat frame is movable between a raised position and a depressed position; and
a seat base coupled with the seat frame and extending between the first and second lateral members.

8. The lift-assist wheelchair of claim 7, wherein the first lateral member is pivotally coupled with the first side frame and the second lateral member is pivotally coupled with the second side frame.

9. The lift-assist wheelchair of claim 7, wherein the first arm is operably coupled with the first lateral member of the seat frame and the second arm is operably coupled with the second lateral member of the seat frame.
